(19) United States
(12) Patent Application Publication
(10) Pub. No.: US 2004/0204124 A1
(43) Pub. Date: Oct. 14, 2004

(54) Method of minimizing the quantity of information stored in a wireless device

(76) Inventor: Lowell Lete Campbell, Carlsbad, CA (US)

Correspondence Address: DON GREEN / DENSO INTERNATIONAL AMERICA INC., LA LABORATORIES, 5770 ARMADA DRIVE, CARLSBAD, CA, 92009, US

(21) Appl. No.: 10/063,725

(22) Filed: May 8, 2002

(51) Int. Cl. H04B 1/38

(52) U.S. Cl. 455/566; 455/414.1

(57) ABSTRACT

The present disclosure limits the quantity of information stored on wireless device. Some example devices are cellular telephones, Telematics units, voice of IP computers, and navigation equipment. On the basis of user provided guideline information, an improved program information manager (PIM) identifies those entries that need not be stored in the devices's local memory, and uploads these entries to a remote server database. The information is then made available to the user for download on an “as-needed” basis. The most important entries are given priority for using limited local memory. Example wireless connections include satellite, a short range wireless (802.11, Bluetooth), or an infrared optical system.

### BACKGROUND OF INVENTION

The present disclosure relates to wireless phone devices. Personal Information Managers (PIMS) store personal telephone-related information for a user, or several users, of a wireless phone device. This can be done in phone devices including digital cellular, PCS and other similar “smartphones” capable of exchanging information over a link to a remote server. The stored information at issue typically includes such entries as addresses, phone numbers, scheduled events, and other useful data. The data is stored in the local memory on the phone.

The quantity of information that could be accumulated is sometimes greater than the amount of local memory in the phone that is available to store such information. This is particularly the case with phones equipped with caller ID functionality, where caller id entries may be automatically generated and stored locally on the phone.

Adding memory is expensive and adds to the overall cost of the phone device. Many smartphones are typically also equipped with software that allows the phone user to have their locally-stored phone data also mirrored on other personal databases located on web servers and personal computers (PCs). It can be difficult for a user to maintain database synchronization with their other personal databases as additional information is added.

### SUMMARY OF INVENTION

The present disclosure limits the quantity of information stored on wireless device. Some example devices are cellular telephones, Telematics units, voice of IP computers, and navigation equipment. On the basis of user provided guideline information, an improved program information manager (PIM) identifies those entries that need not be stored in the devices's local memory, and uploads these entries to a remote server database. The information is then made available to the user for download on an “as-needed” basis. The most important entries are given priority for using limited local memory. Example wireless connections include satellite, a short range wireless (802.11, Bluetooth), or an infrared optical system.

### BRIEF DESCRIPTION OF DRAWINGS

FIG. 1 shows a wireless phone including a PIM for uploading and downloading personal user entries over a link to a remote server in accordance with a preferred embodiment.

FIG. 2 is a chart of the operational flow of the PIM during upload of entry data from the wireless phone to a database in the remote server.

FIG. 3 is a flowchart of the operational flow of the PIM during download of entry data from the database in the remote server to local memory in the wireless phone for immediate display to the wireless phone user.

### DETAILED DESCRIPTION

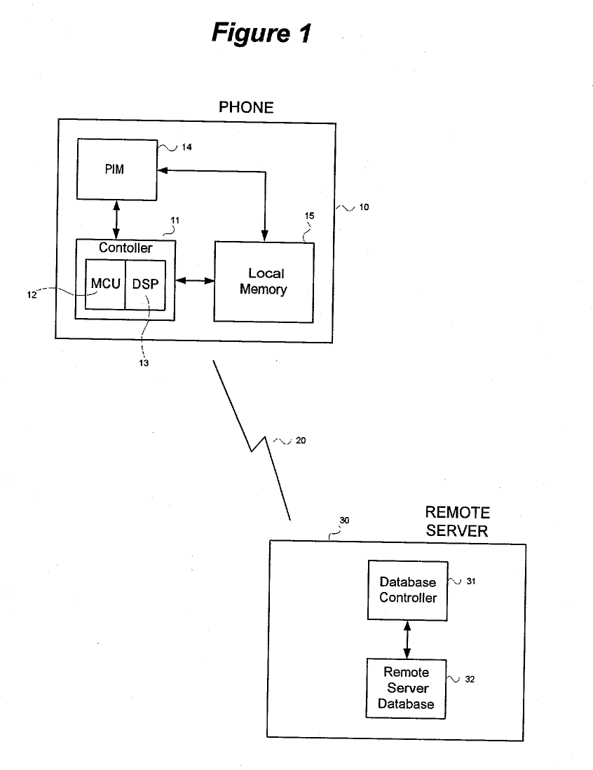

FIG. 1 shows a wireless phone 10, such as, a cellular radiotelephone.

The wireless phone 10 includes a controller 11 which functions in a conventional manner to demodulate received transmissions, decode any encoded voice or other transmissions, and to generally perform high speed signal processing with the received transmissions. The controller 11 has a microprocessor control unit (MCU) 12 and a digital signal processor (DSP) 13. The MCU 12 is connected to the DSP 13 and operates on the decoded information to generally control the operations of the phone to place and receive calls, to operate a keypad and a display on the phone, to monitor the charge state of a battery, and other such well understood functions.

The wireless phone 10 also includes various memories 14, 15, wherein are stored a plurality of constants and variables that are used by the controller 11 during the operation of the phone. In accordance with the present invention, local memory 15 stores a user's personal information or profile. Memory 14 stores an operating program, generally referred to as a Personal Information Manager (PIM), which functions to manage information in local memory 15. This personal information is stored in local memory 15 in the form of user-selectable entries. These entries may include schedule data describing timed events (e.g., meeting times, appointments, etc.) and contact data describing user contacts (e.g., name, address, phone number, etc.). Such entries are generated either automatically, or through additional user input, in a conventional manner. The MCU 12 executes the computer program instructions of the PIM 14.

In accordance with the present disclosure, as a final step the personal information is deleted from local memory 15 and uploaded over a communication link 20 to a remote server 30. The remote server 30 is shown comprising a remote server controller 31 which processes the uploaded personal information. The controller 31 manipulates the uploaded user-selectable entries and stores them in retrievable form in a remote server database 32. When a message is received from the phone 10 requesting a relevant portion of the user-selectable entries in database 32, the controller 31 downloads such data to the local memory 15. The downloaded data is retrieved by the PIM 14 and presented to the user in a predefined format.

It is contemplated that the remote server 30 functionality is provided by the fixed infrastructure over which a wireless phone communicates. As is well known in the art of wireless communications, voice mail, digital email, caller ID and other type of user specific data travels across such fixed infrastructure and over the air to each individual wireless phone 10.

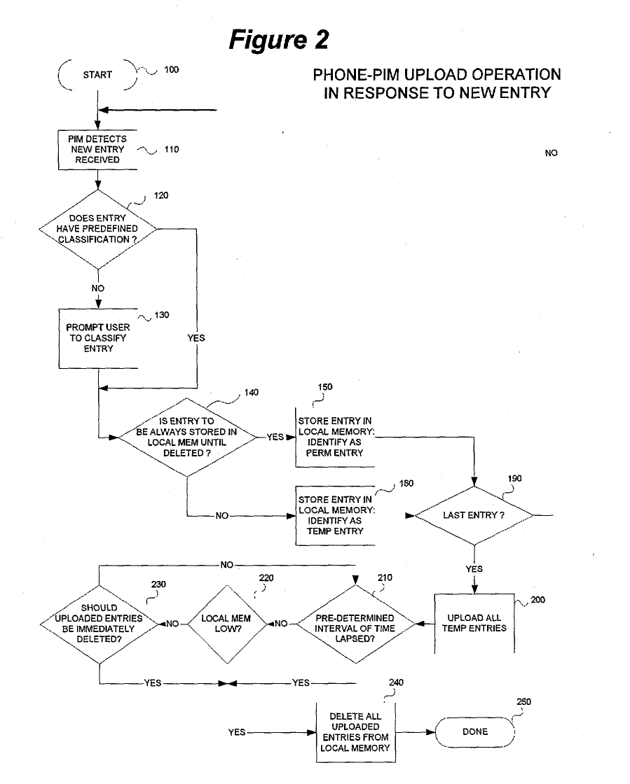

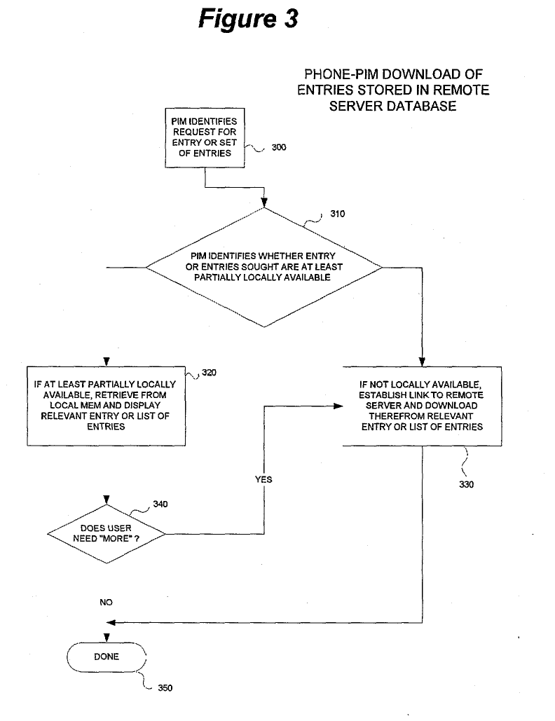

The present invention is described in greater detail in connection with the PIM operational flow diagrams shown in FIGS. 2 and 3.

FIG. 2 shows user-selectable entries such as caller ID contacts which are automatically generated, or scheduling data which a phone user typically manually generates. These are initially stored by the PIM 14 in local memory 15 on the phone 10. The PIM 14 detects each new entry (step 110) and processes it based on a predetermined set of rules described below.

In accordance with a preferred embodiment, the PIM 14 recognizes that a new entry is about to be created. Before storing it in local memory tags, it classifies the entry in one of various ways.

If the entry is a newly-received caller ID entry which the user wants to add to his or her personal information data for retrieval at a later date, the PIM 14 might query the user as to whether the entry should be a “permanent” or a “temporary” entry. A permanent entry is defined as any entry which is to always reside on the local memory 15 and need not be uploaded to the remote server 30 (except for backup purposes). A temporary entry, by comparison, is always uploaded. It will be eventually deleted from local memory 15 to free up memory space. The user, server or software default may establish in advance that certain data categories, such as caller ID contacts, are always one or the other type of entry, then querying the user (step 130) is unnecessary.

Once entry type is determined (step 140), the PIM 14 tags each entry as permanent (step 150) or temporary (step 180) and stores it in an addressable, accessible manner in local memory 15.

In a preferred embodiment, a plurality of user-selectable entries are processed by the PIM 14 as a set. In such case, the PIM 14 must repeat steps 110-140 for each and every entry (i.e., permanent and temporary) until all entries are stored in local memory (steps 150, 180).

Nothing more need be done to the permanent entries. The PIM 14 waits idly until a new entry is detected for processing.

The temporary entries are uploaded in due course to the remote server 30 where they are stored in remote server database 32.

Uploading data (step 200) requires that communication link 20 is active. If the phone is powered-on and currently affiliated to its corresponding cell site, then uploading might occur automatically after a last entry is detected (step 190) and stored in local memory 15. Alternatively, a wireline link might also be set up to upload the information directly or over a network such as, the Internet to the fixed infrastructure where the remote server 30 is located. In this latter scenario, since the information is all of a personal and user-specific nature, the remote server 30 need not be part of the fixed infrastructure.

The link 20 is preferably a wireless link that is active whenever the phone 10 is powered-up. In this way, when the PIM 14 requests a temporary entry that is not stored locally, the PIM 14 can retrieve this entry from the remote server database 32 with minimal delay to the phone user.

However, given that wireless link 20 is a shared resource, it may not be feasible for the PIM to rely on uninterrupted access to the remote server 30. Accordingly, certain temporary entries might not be deleted immediately after uploading to the server 30.

After uploading the temporary entries to the server 30, the PIM 14 waits a predetermined interval of time before deleting the locally-stored temporary entries from memory 15 (steps 210, 240). It is further possible to condition the entry-deletion on the basis of how much memory is still available in which to store new entries (steps 220, 240). In this way, even if the time interval has not lapsed since the last upload, a memory low status can force deletion of uploaded entries.

The PIM 14 might also take into account the nature of the entry that was previously uploaded. For example, uploaded caller ID entries may not be as critical as user-created entries. The PIM 14 may therefore automatically remove the less critical temporary, caller ID entries from memory 15 immediately after uploading (steps 230, 240) to the remote server 30.

FIG. 3 shows how information in the PIM 14 is typically requested in response to a user action. Most typically, the phone user enters keypad instructions which cause the MCU 12 to call on the PIM 14 (step 300) program to access a specific set of user-selectable entries. These entries are then retrieved from local memory 15, either individually or as a set, by the PIM 14 and displayed to the user.

Prior to being retrieved, the PIM 14 must determine whether the entries sought are permanent or temporary. If temporary, the PIM determines whether they are locally available (step 310). The PIM 14 retrieves those desired entries that are locally available from local memory 15 and displays them to the user for selection (step 320). The number of entries simultaneously displayed is, of course, limited by the viewing area in the phone display. Accordingly, the PIM 14 must display the information to be displayed either individually or in groups, until the user finds the specific entry which is sought (step 320). The display of user-selectable entries stored in local memory 15 is conventional.

If the desired entry or set of entries resides in the server 30, the PIM 14 calls on the MCU 12 to establish a link to the server 30. Once the link 20 is active, PIM 14 requests the remote server controller 31 to download the relevant information (step 330). In the case where the information to be downloaded has more than a predefined size of user-selectable entries, the set of desired entries is parsed into subsets. After all the contents of a subset have been viewed by the user, those contents are overwritten with a subsequent subset of entries (step 330). This process is repeated until the user is satisfied (step 340).

For a phone user accustomed to receiving many calls, local phone memory could quickly become depleted with information such as caller ID contact information. The present invention finds utility where the user-selectable entries are caller ID contact information.

In sum, the present disclosure limits the quantity of information stored on a wireless phone. An information manager identifies entries which can be uploaded to a remote server database. The information is then made available to the user for download on an “as-needed” basis. This allows using less memory.

Also, because a more manageable, reduced-quantity of data is stored locally, in instances where mirroring of data to other databases is desirable, a phone user is not subject to as great database synchronization problems.

Although a few embodiments have been described, various modifications and enhancements may be possible without departing from the following claims. For example, instead of a cellular wireless connection the wireless connection could be satellite, a short range wireless communication system, or an infrared optical system. Some examples of other devices that could be used in addition to a phone are Telematics devices, voice over IP computers, or navigation equipment.

1. A method of managing information in a portable wireless device comprising:
prompting the user to classify a user-selectable entry in local memory;
identifying at least one user-selectable entry stored in the local memory of the portable wireless device;
uploading the at least one user-selectable entry to a database in a remote server;
deleting the at least one user-selectable entry from the local memory of the portable telephone;
identifying a request for information that is in an entry that has been deleted and
retrieving the deleted entry from the remote server to the phone in response to said identifying.

2. The method of claim 1, wherein the at least one user-selectable entry is at least one of an address, a phone number, and a scheduled event.

3. The method of claim 1, wherein the at least one user-selectable entry is a user-created entry.

4. The method of claim 1, wherein the at least one user-selectable entry comprises a plurality of caller id entries.

5. The method of claim 1, wherein the local memory includes user-selectable entries that are permanent entries and which are not uploaded to the remote server.

6. The method of claim 5, further comprising uploading the permanent entries to a personal web server or personal computer to synchronize the associated database with contents in the local memory.

7. The method of claim 6, further comprising prompting the user to classify a user-selectable entry in local memory as being either a permanent or a temporary entry, of which only temporary entries are uploaded to the remote server.

8. The method of claim 1, wherein said deleting occurs immediately after uploading.

9. The method of claim 1, wherein said deleting occurs after a predetermined time has elapsed after uploading.

10. The method of claim 1, wherein said deleting occurs upon detection of a memory low condition with respect to the local memory.

11. An apparatus comprising a machine-readable storage medium having executable instructions for minimizing the quantity of information stored in a local memory of a portable phone, the instructions enabling the machine to:
prompting the user to classify a user-selectable entry in local memory;
identify at least one user-selectable entry presently stored in the local memory of the phone;
send the at least one user-selectable entry to a memory in a remote server;
delete the at least one user-selectable entry from local memory;
identify a phone user request for information in the at least one user-selectable temporary entry; and
download the at least one user-selectable temporary entry from the remote server to the phone in response to the phone user request.

12. The apparatus of claim 11, wherein the at least one user-selectable temporary entry is at least one of an address, a phone number, and a scheduled event.

13. The apparatus of claim 11, wherein the at least one user-selectable temporary entry is a user-created entry.

14. The apparatus of claim 11, wherein the at least one user-selectable temporary entry comprises a plurality of caller id entries.

15. The apparatus of claim 11, wherein the local memory includes user-selectable entries that are permanent entries and which are not uploaded to the remoter server.

16. The apparatus of claim 15, further comprising an instruction for uploading the permanent entries to a personal web server or personal computer to synchronize the associated database with contents in the local memory.

17. The apparatus of claim 16, further comprising an instruction for prompting the user to classify a user-selectable entry in local memory as being either a permanent or a temporary entry, of which only temporary entries are uploaded to the remote server

18. The apparatus of claim 11, wherein deleting occurs immediately after uploading.

19. The apparatus of claim 11, wherein deleting occurs after a predetermined time has lapsed.

20. The apparatus of claim 11, wherein deleting occurs upon detection of a memory low condition with respect to the local memory.
